(19) United States
(12) Patent Application Publication
(10) Pub. No.: US 2026/0116145 A1
(43) Pub. Date: Apr. 30, 2026

(54) HVAC KINEMATICS TO MITIGATE MECHANICAL HYSTERESIS

(71) Applicant: Hanon Systems, Daejeon (KR)

(72) Inventors: Devon Nimer, Novi, MI (US); Shankar Patil, Novi, MI (US); David Miller, Novi, MI (US); Jennifer Petrowski, Novi, MI (US)

(21) Appl. No.: 18/927,060

(22) Filed: Oct. 25, 2024

(51) Int. Cl. B60H 1/00

(52) U.S. Cl. CPC B60H 1/00678; B60H 2001/00707

(57) ABSTRACT

An air-handling system for a heating, ventilation, and air conditioning system comprises a main housing, one or more selectively positionable doors, and a control mechanism. At least one of the doors is disposed in a mixing and conditioning section of the main housing to control a temperature of a flow of air to a delivery section of the main housing. Additionally, at least one of the doors is disposed in the delivery section of the main housing to control a flow of conditioned air through a plurality of conduits. The control mechanism includes one or more cam gears configured to selectively control each of the doors to provide temperature control for various modes of operation of the air-handling system. One of the cam gears includes a cam track having one or more radially inward and/or radially outward segments to mitigate mechanical hysteresis of the doors.

### FIELD

The invention relates to a climate control system for a vehicle and more particularly to a climate control system for a heating, ventilating, and air conditioning system for the vehicle.

### BACKGROUND

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilation and air conditioning (HVAC) air-handling system. The air-handling system conditions air flowing therethrough and distributes the conditioned air throughout the passenger compartment.

The air-handling system commonly employs a plurality of selectively positionable doors within a housing to control a flow of air therethrough. For example, the air-handling system may include an inlet door for controlling a flow of into the air-handling system and a temperature door for controlling a flow of air through heat exchangers that may be disposed within the housing. In some cases, the temperature door may be adjusted between a first position configured to direct an entirety of the flow of air through a heater core to add thermal energy to the flow of air, and a second position configured to direct the entirety of the flow of air through an evaporator core to remove thermal energy from the flow of air. The temperature door may further be adjusted to an intermediate position to direct a first portion of the flow of air to the heater core and a second portion of the flow of air to the evaporator core. In other cases, the evaporator core may be disposed upstream of the temperature door to cause the entirety of the flow of air to flow through the evaporator core before encountering the temperature door. In such cases, the temperature door may be adjusted between a first position configured to direct the entirety of the flow of air through the heater core and a second position configured to bypass the entirety of the flow of air through a bypass passageway, wherein the flow of the air is not subjected to additional heating by the heater core. The temperature door may further be adjusted to an intermediate position to direct a first portion of the flow of air through the heater core and a second portion of the flow of air through the bypass passageway bypassing the heater core.

The air-handling system may also include a mode door configured to control a distribution of the flow of air to the passenger compartment of the vehicle. For example, in a first position, or defrost/cabin mode, the flow of air may be directed to a first conduit and provided to a vent directed towards a windshield or a passenger within the passenger compartment. In a second position, or floor mode, the flow of air may be directed to a second conduit and provided to a vent directed towards a floor or footwell area of the passenger compartment. Additionally, the mode door may be positioned intermediate the first position and the second position, in a mixed mode, to provide a first portion of the flow of air to the first conduit and a second portion of the flow of air to the second conduit.

To allow the temperature of the flow of air to be fully adjusted between a cold temperature and a hot temperature for each of the modes, each of the doors must be rotated independently of each other. Typically, independent rotation of the temperature door and the mode door requires each of the doors to be driven by one or more actuators and kinematics linkages. Inconsistent positioning of the doors, however, can lead to inaccurate temperature control and airflow in the passenger compartment that does not meet vehicle manufacturer requirements. In some circumstances, a position of the doors depends on a direction of travel of the kinematics. In other words, if the actuator approached in a clockwise direction, the door would have a different position than when the actuator approached in a counter-clockwise direction.

Accordingly, it would be desirable to develop kinematics of an air-handling system including a cam gear that mitigates mechanical hysteresis in the selectively positionable doors, more particularly the inlet, temperature, and mode doors, while increasing temperature and airflow accuracy, improving design robustness, and reducing manufacturing complexity.

### SUMMARY

In concordance and agreement with the presently described subject matter, kinematics of an air-handling system including a cam gear that mitigates mechanical hysteresis in the selectively positionable doors, more particularly the inlet, temperature, and mode doors, while increasing temperature and airflow accuracy, improving design robustness, and reducing manufacturing complexity, have been newly designed. Shortcomings of the prior art are overcome, and additional advantages are provided through the systems and the methods in accordance with the present disclosure.

In one embodiment, an air-handling system for a heating, ventilation, and air conditioning system of a motor vehicle having a passenger compartment, the air-handling system comprises: a main housing having one or more selectively positionable doors rotatably disposed therein; and a control mechanism including a first cam gear rotatable about a rotational axis, wherein the first cam gear includes a cam track formed on a first face thereof, wherein a shape of the cam track determines a rotational position of at least one of the one or more selectively positionable doors, wherein the cam track includes a first end, a second end, and a continuous path extending between the first end and the second end, and wherein the continuous path includes at least one at least one radially outward segment having a distance from the rotational axis greater than a distance from the rotational axis of a leading portion of the continuous path and a distance from the rotational axis of a trailing portion of the continuous path.

As aspects of some embodiments, the cam track on the first face of the first cam gear extends in a circumferential direction around the rotational axis.

As aspects of some embodiments, the control mechanism further comprises a linkage/gear including a cam follower slidably engaging the cam track on the first face of the first cam gear.

As aspects of some embodiments, the linkage/gear rotates in response to the cam follower sliding along the cam track on the first face of the first cam gear.

As aspects of some embodiments, the shape of the cam track biases the cam follower to one side of the cam track to mitigate a mechanical hysteresis of the one or more selectively positionable doors.

As aspects of some embodiments, the first cam gear includes a cam track on a second face thereof.

As aspects of some embodiments, a shape of the cam track on the second face of the first cam gear determines a rotational position of at least one of the one or more selectively positionable doors.

As aspects of some embodiments, the cam track on the second face of the first cam gear extends in a circumferential direction around the rotational axis.

As aspects of some embodiments, the control mechanism further comprises a linkage/gear including a cam follower slidably engaging the cam track on the second face of the first cam gear.

As aspects of some embodiments, the linkage/gear rotates in response to the cam follower sliding along the cam track on the second face of the first cam gear.

As aspects of some embodiments, the control mechanism further comprises a second cam gear having a rotational axis.

As aspects of some embodiments, the second cam gear includes a cam track on a face thereof.

As aspects of some embodiments, a shape of the cam track on the face of the second cam gear determines a rotational position of at least one of the one or more selectively positionable doors.

As aspects of some embodiments, the cam track on the face of the second cam gear extends in a circumferential direction around the rotational axis of the second cam gear.

As aspects of some embodiments, the control mechanism further comprises a linkage/gear including a cam follower slidably engaging the cam track on the face of the second cam gear.

As aspects of some embodiments, the control mechanism is configured to rotate each of the one or more selectively positionable doors to predetermined rotational positions associated with predetermined angles of rotation of at least one actuator driving the control mechanism.

As aspects of some embodiments, at least one of the one or more selectively positionable doors rotatably disposed in the main housing is a temperature door or a mode door.

As aspects of some embodiments, a shape of the cam track on the first face of the first cam gear determines a rotational position of the temperature door or the mode door.

As aspects of some embodiments, the control mechanism further comprises at least one linkage/gear operably connecting the temperature door or the mode door to the first cam gear.

As aspects of some embodiments, the control mechanism is configured to rotate each of the temperature door or the mode door to predetermined rotational positions associated with predetermined angles of rotation of at least one actuator driving the control mechanism.

### BRIEF DESCRIPTION OF THE DRAWINGS

The above, as well as other advantages of the present disclosure, will become readily apparent to those skilled in the art from the following detailed description, particularly when considered in the light of the drawings described hereinafter.

FIG. 1 is a cross-sectional view showing an interior of a main housing of an air-handling system according to an embodiment of the invention;

FIG. 2 is an exploded perspective view of a control mechanism of the air-handling system according to an embodiment of the invention;

FIG. 3 is a front elevational view of the control mechanism of FIG. 2;

FIG. 4 is a front elevational view showing a cam gear of the control mechanism of FIGS. 2 and 3;

FIG. 5 is a rear elevational view showing the cam gear of the control mechanism of FIGS. 2-4;

FIG. 6 is a front perspective view showing the cam gear of the control mechanism of FIGS. 2-5;

FIG. 7 is a rear perspective view showing the cam gear of the control mechanism of FIGS. 2-6;

FIG. 8 is a graphical illustration a relationship between angle of one or more cam gears and a rotational position of each of a plurality of mode doors of the air-handling system of FIGS. 1-2; and

FIG. 9 is a fragmentary schematic side elevational view of a motor vehicle having the air-handling system of FIGS. 1-2.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

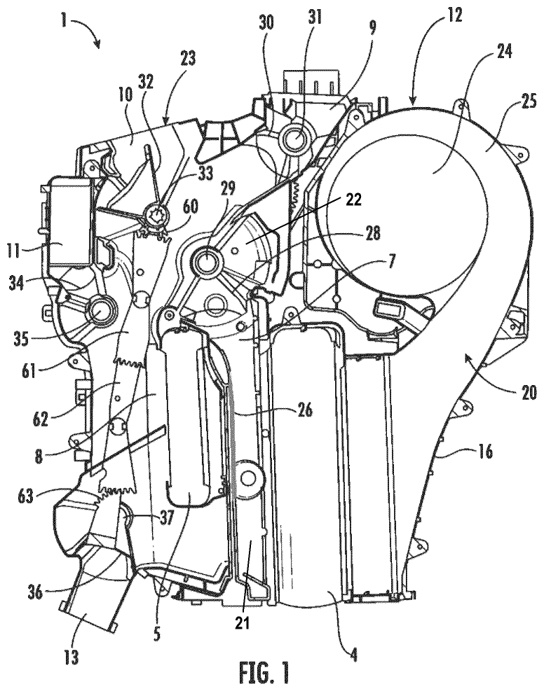

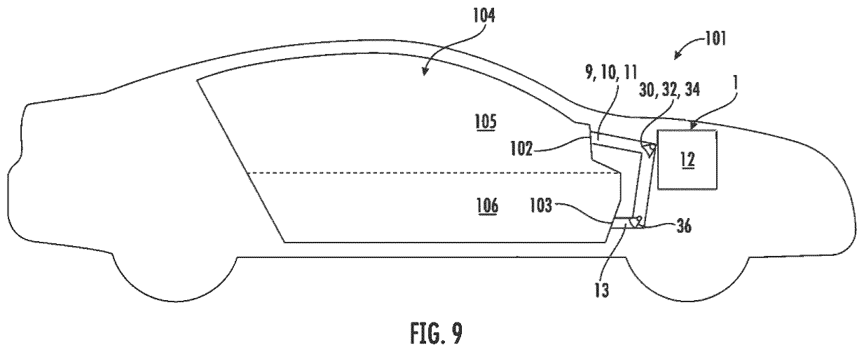

FIG. 1 illustrates an air-handling system 1 of a heating, ventilating, and air conditioning (HVAC) system for a motor vehicle 101 (FIG. 9) according to an embodiment of the disclosure. As used herein, the term air can refer to fluid in a gaseous state, fluid in a liquid state, or any combination thereof. The air-handling system 1 typically provides heating, ventilation, and air conditioning for a passenger compartment 104 (FIG. 9) of the vehicle 101. The air-handling system 1 is configured for installation between vehicle sheet metal (not shown) and an interior trim panel (not shown). The air-handling system 1 can be installed in other locations in the vehicle 101 as desired such as under an instrument panel, to a dash panel, in a trunk, in a console, under a floor, in a headliner, or in an engine compartment, for example.

The air-handling system 1 includes a hollow main housing 12. The main housing 12 may be formed by the cooperation of a pair of housing shells 16. In some embodiments, the housing shells 16 interface with each other along peripheral regions thereof to form the hollow main housing 12. The housing shells 16 may be formed from plastic, but other materials can be used, as desired. In other embodiments, the main housing 12 may be formed by the cooperation of three or more separately formed components or housing portions, as desired.

FIG. 1 illustrates a hollow interior of the main housing 12 to better show the flow path for the flow of air flowing through the main housing 12. The main housing 12 includes an inlet section 20, a conditioning section 21, a mixing section 22, and a delivery section 23. The inlet section 20 includes an air inlet 24 in fluid communication with a supply of air and an inlet conduit 25 providing fluid communication between the supply of air and the conditioning section 21 of the main housing 12. A selectively positionable inlet door (not shown) may be disposed in the inlet section 20 to control the flow of air into and through the air inlet 24. The supply of air can be provided from outside of the vehicle 101, recirculated from the passenger compartment 104 of the vehicle 101, or a mixture of the two, for example. The air inlet 24 may be formed adjacent a blower or fan of a blower assembly (not shown) configured to promote a flow of the supply of air through the inlet conduit 25. If desired, a filter (not shown) can be provided upstream or downstream of the inlet section 20 to filter out debris or contaminants carried by the supply of air.

The conditioning section 21 may include an evaporator core 4 and a heater core 5. The evaporator core 4 may form a portion of a primary refrigerant circuit of the air conditioning system associated with the air-handling system 1. The evaporator core 4 is configured to exchange heat energy between the flow of air and the refrigerant flowing through the evaporator core 4 to cool and/or dehumidify the flow of air. Although described as an evaporator core, it should be understood that any form of cooling device in heat exchange relationship with any device or system of the motor vehicle 101 may be employed for use with the air-handling system 1 without departing from the scope of the present invention. The heater core 5 may form a radiator associated with a coolant circuit used to cool an engine of the motor vehicle 101. The heater core 5 is further configured to exchange heat energy between the flow of air and a coolant circulated through the coolant circuit to heat the flow of air. Alternatively, the heater core 5 may be in heat exchange relationship with a fluid used to cool a battery or other heat producing device associated with the motor vehicle 101 or the heater core 5 may be a heating device configured to produce heat using an electrical source. It should be understood that any form of heating device suitable for heating a flow of air therethrough may be used in place the heater core 5 without departing from the scope of the present invention.

As shown in FIG. 1, the evaporator core 4 may be disposed at an inlet region of the conditioning section 21 immediately downstream of the inlet conduit 25 of the inlet section 20. The evaporator core 4 extends across an entirety of a flow area at the inlet region of the conditioning section 21 to cause the entirety of the flow of air to pass through the evaporator core 4, thereby cooling and/or dehumidifying the entirety of the flow of air as the flow of air enters the conditioning section 21.

After flowing through the evaporator core 4 the flow of air encounters a baffle wall 26. A cold air passageway 7 is formed to one side of the baffle wall 26 and a warm air passageway 8 is formed to a second side of the baffle wall 26. The cold air passageway 7 may alternatively be referred to as the first passageway 7 while the warm air passageway 8 may alternatively be referred to as the second passageway 8, as desired. The warm air passageway 8 includes the heater core 5 disposed therein. The heater core 5 may be disposed across an entirety of a flow area of the warm air passageway 8, as desired. In other embodiments, only a portion of the flow area of the warm air passageway is covered by the heater core 5, as desired.

A selectively positionable temperature door 28 is rotatably coupled to the main housing 12 at a downstream end of each of the cold air passageway 7 and the warm air passageway 8. The temperature door 28 is disposed on a temperature door shaft 29 that is rotatably disposed in the main housing 12. A first end of the temperature door shaft 29 is received in an aperture (not shown) of a first one of the housing shells 16 and a second end of the shaft is received through an aperture (not shown) of a second one of the housing shells 16. The temperature door shaft 29 extends from a first end of the temperature door 28 to a second end of the temperature door 28. The temperature door shaft 29 may extend outwardly beyond the first end of the temperature door 28 and outwardly beyond the second end of the temperature door 28. The temperature door shaft 29 may alternatively be flush with or recessed from the ends of the temperature door 28, as desired.

The temperature door 28 may be positioned in a first position wherein the temperature door 28 is rotated to block passage of the flow of air through the warm air passageway 8 and into the mixing section 22. When the temperature door 28 is in the first position the entirety of the flow of air is directed through the opened cold air passageway 7 and into the mixing section 22 immediately after flowing through the evaporator core 4. The temperature door 28 may alternatively be positioned in a second position wherein the temperature door 28 is rotated to block passage of the flow of air through the cold air passageway 7 and into the mixing section 22. When the temperature door 28 is in the second position the entirety of the flow of air is directed through the opened warm air passageway 8 and into the mixing section 22 immediately after flowing through the heater core 5.

The temperature door 28 may alternatively be rotated to an intermediate position between the first position and the second position. When in the intermediate position, a first partial air flow of the flow of air may flow through the cold air passageway 7, past the temperature door 28, and into the mixing section 22 while a second partial air flow of the flow of air may flow through the warm air passageway 8 including the heater core 5, past the temperature door 28, and into the mixing section 22. The first partial air flow and the second partial air flow are then recombined and mixed in the mixing section 22. As should be understood, the temperature door 28 may be adjustable to a variety of intermediate positions to control a percentage of the flow of air passing through the cold air passageway 7 and the warm air passageway 8, respectively, to control a temperature of the flow of air according to desired settings of a passenger within the passenger compartment 104 of the motor vehicle 101.

The delivery section 23 of the main housing 12 includes a plurality of conduits 9, 10, 11, 13. More or less conduits then shown may be formed in the delivery section 23 of the main housing 12 if desired. The conduits 9, 10, 11 may be an “upper conduits” for directing the flow of air towards one or more “upper vents” 102 (FIG. 9) of the air-handling system 1 directed towards a first region 105 of the passenger compartment 104 including a windshield and/or a passenger within the passenger compartment 104. The conduit 13 may be a “lower conduit” for directing the flow of air towards one or more “lower vents” 103 (FIG. 9) directed towards a second region 106 of the passenger compartment 104 including a console area of the passenger compartment 104. However, the conduits 9, 10, 11, 13 may direct the flow of air to various different regions or vents of the air-handling system 1 without departing from the scope of the present invention.

A selectively positionable mode door 30 is rotatably coupled to the main housing 12 between the mixing section 22 and the delivery section 23. The mode door 30 is disposed on a mode door shaft 31 that is rotatably disposed in the main housing 12. A first end of the mode door shaft 31 is received in an aperture (not shown) of a first one of the housing shells 16 and a second end of the mode door shaft 31 is received in an aperture (not shown) of the second one of the housing shells 16. The mode door shaft 31 extends from a first end of the mode door 30 to a second end of the mode door 30. The mode door shaft 31 may extend outwardly beyond the first end of the mode door 30 and outwardly beyond the second end of the mode door 30. The mode door shaft 31 may alternatively be flush with or recessed from the ends of the mode door 30, as desired.

The mode door 30 may be positioned in a first position wherein the mode door 30 is rotated to block passage of the flow of air into the conduit 9. In some instances, the mode door 30 may be referred to as a “defrost door”. When in the first position, the entirety of the flow of air is caused to flow through at least one of the conduits 10, 11, 13. The mode door 30 may alternatively be positioned in a second position wherein the mode door 30 is rotated to permit at least a partial flow, if not an entirety, of the flow of air to flow into and through the conduit 9. The first position of the mode door 30 accordingly may correspond to a “floor mode”, a “panel mode”, or a “panel and floor mode” of the air-handling system 1 and the second position of the mode door 30 accordingly may correspond to a “defrost mode” of the air-handling system 1.

The mode door 30 may alternatively be rotated to an intermediate position between the first position and the second position. When in the intermediate position of the mode door 30, a partial flow of air flows through the conduit 9, while another partial flow of air may be caused to flow through at least one of the conduits 10, 11, 13. The intermediate position of the mode door 30 accordingly may correspond to a “mixed mode” or a “panel, floor, and defrost mode” of the air-handling system 1. As should be understood, the mode door 30 may be adjusted to a variety of intermediate positions to control a percentage of the flow of air directed to each of the conduits 10, 11, 13 and the conduit 9 to control a venting of the flow of air into the passenger compartment 104 of the motor vehicle 101.

Another selectively positionable mode door 32 is rotatably coupled to the main housing 12 between the mixing section 22 and the delivery section 23. The mode door 32 is disposed on a mode door shaft 33 that is rotatably disposed in the main housing 12. A first end of the mode door shaft 33 is received in an aperture (not shown) of a first one of the housing shells 16 and a second end of the mode door shaft 33 is received in an aperture (not shown) of the second one of the housing shells 16. The mode door shaft 33 extends from a first end of the mode door 32 to a second end of the mode door 32. The mode door shaft 33 may extend outwardly beyond the first end of the mode door 32 and outwardly beyond the second end of the mode door 32. The mode door shaft 33 may alternatively be flush with or recessed from the ends of the mode door 32, as desired.

The mode door 32 may be positioned in a first position wherein the mode door 32 is rotated to block passage of the flow of air into the conduit 10. In certain embodiments, the mode door 32 may be referred to as a “panel door”. When in the first position, an entirety of the flow of air is caused to flow through at least one of the conduits 9, 11, 13. The mode door 32 may alternatively be positioned in a second position wherein the mode door 32 is rotated to permit passage of at least a partial flow, if not an entirety, of the flow of air into and through the conduit 10. The first position of the mode door 32 accordingly may correspond to a “defrost mode” or “floor mode” of the air-handling system 1 and the second position of the mode door 32 accordingly may correspond to a “panel mode” of the air-handling system 1.

The mode door 32 may alternatively be rotated to an intermediate position between the first position and the second position, as shown in FIG. 1. When in the intermediate position of the mode door 32, a partial flow of air flows through the conduit 10 while another partial flow of air may be caused to flow through at least one of the conduits 9, 11, 13. The intermediate position of the mode door 32 accordingly corresponds to a “mixed mode”, a “panel and floor mode” or a “panel, floor, and defrost mode” of the air-handling system 1. As should be understood, the mode door 32 may be adjusted to a variety of intermediate positions to control a percentage of the flow of air directed to each of the conduits 9, 11, 13 and the conduit 10 to control a venting of the flow of air into the passenger compartment 104 of the motor vehicle 101.

Another selectively positionable mode door 34 is rotatably coupled to the main housing 12 between the mixing section 22 and the delivery section 23. The mode door 34 is disposed on a mode door shaft 35 that is rotatably disposed in the main housing 12. A first end of the mode door shaft 35 is received in an aperture (not shown) of a first one of the housing shells 16 and a second end of the mode door shaft 35 is received in an aperture (not shown) of the second one of the housing shells 16. The mode door shaft 35 extends from a first end of the mode door 34 to a second end of the mode door 34. The mode door shaft 35 may extend outwardly beyond the first end of the mode door 34 and outwardly beyond the second end of the mode door 34. The mode door shaft 35 may alternatively be flush with or recessed from the ends of the mode door 34, as desired.

The mode door 34 may be positioned in a first position wherein the mode door 34 is rotated to block passage of the flow of air into the conduit 11. In some embodiments, the mode door 34 may be referred to as a “floor door”. When in the first position, an entirety of the flow of air is caused to flow through at least one of the conduits 9, 10, 13. The mode door 34 may alternatively be positioned in a second position wherein the mode door 34 is rotated to permit passage of at least a partial flow, if not an entirety, of the flow of air into and through the conduit 11. The first position of the mode door 34 accordingly may correspond to a “defrost mode” or “panel mode” of the air-handling system 1 and the second position of the mode door 34 accordingly may correspond to a “floor mode” of the air-handling system 1.

The mode door 34 may alternatively be rotated to an intermediate position between the first position and the second position. When in the intermediate position of the mode door 34, a partial flow of air flows through the conduit 11 while another partial flow of air may be caused to flow through at least one of the conduits 9, 10, 13. The intermediate position of the mode door 34 accordingly corresponds to a “mixed mode”, a “panel and floor mode” or a “panel, floor, and defrost mode” of the air-handling system 1. As should be understood, the mode door 34 may be adjusted to a variety of intermediate positions to control a percentage of the flow of air directed each of the conduits 9, 10, 13 and the conduit 11 to control a venting of the flow of air into the passenger compartment 104 of the motor vehicle 101.

Yet another selectively positionable mode door 36 is rotatably coupled to the main housing 12 between the mixing section 22 and the delivery section 23. The mode door 36 is disposed on a mode door shaft 37 that is rotatably disposed in the main housing 12. A first end of the mode door shaft 37 is received in an aperture (not shown) of a first one of the housing shells 16 and a second end of the mode door shaft 37 is received in an aperture (not shown) of the second one of the housing shells 16. The mode door shaft 37 extends from a first end of the mode door 36 to a second end of the mode door 36. The mode door shaft 37 may extend outwardly beyond the first end of the mode door 36 and outwardly beyond the second end of the mode door 36. The mode door shaft 37 may alternatively be flush with or recessed from the ends of the mode door 36, as desired.

The mode door 36 may be positioned in a first position wherein the mode door 36 is rotated to block passage of the flow of air into the conduit 13. In some embodiments, the mode door 36 may be referred to as a “console door”. When in the first position, an entirety of the flow of air is caused to flow through at least one of the conduits 9, 10, 11. The mode door 36 may alternatively be positioned in a second position wherein the mode door 36 is rotated to permit passage of at least a partial flow, if not an entirety, of the flow of air into and through the conduit 13. The first position of the mode door 36 accordingly may correspond to a “defrost mode” or “floor mode” of the air-handling system 1 and the second position of the mode door 36 accordingly may correspond to a “panel mode” of the air-handling system 1.

The mode door 36 may alternatively be rotated to an intermediate position between the first position and the second position. When in the intermediate position of the mode door 36, a partial flow of air flows through the conduit 13 while another partial flow of air may be caused to flow through at least one of the conduits 9, 10, 11. The intermediate position of the mode door 36 accordingly corresponds to a “mixed mode”, a “panel and floor mode” or a “panel, floor, and defrost mode” of the air-handling system 1. As should be understood, the mode door 36 may be adjusted to a variety of intermediate positions to control a percentage of the flow of air directed each of the conduits 9, 10, 11 and the conduit 13 to control a venting of the flow of air into the passenger compartment 104 of the motor vehicle 101.

The inlet door, temperature door, and the mode doors of the air-handling system may be controlled independently by at least one actuator 3 to achieve a variety of different flow configurations of the flow of air, thereby allowing for a volume, a temperature, and a venting direction of the flow of air to be controlled within the passenger compartment 104 of the motor vehicle 101.

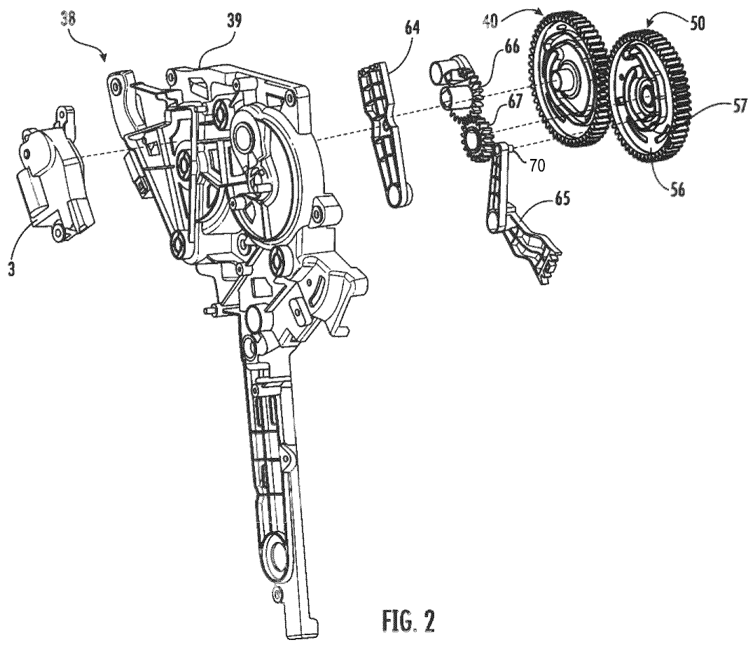

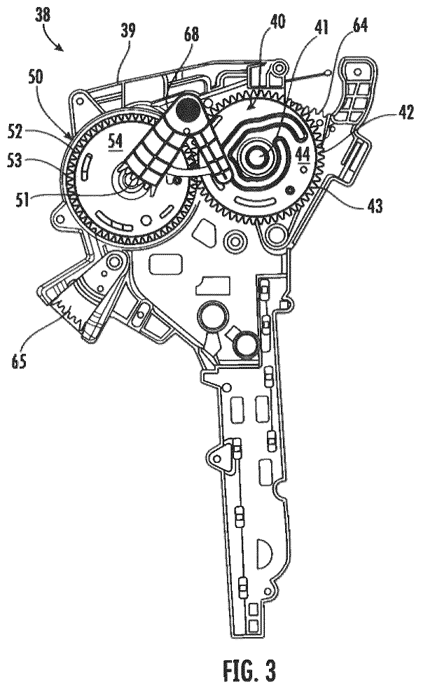

FIGS. 2 and 3 illustrate a control mechanism 38 configured to provide simultaneous control of each of the temperature door 28 and the mode doors 30, 32, 34, 36 while being driven by the actuator 3. It is understood that the control mechanism 38 may be further configured to provide simultaneous control of the inlet door in addition to the temperature door 28 and the mode doors 30, 32, 34, 36, if desired. The control mechanism 38 includes a mounting bracket 39, a cam gear 40, a cam gear 50, and various other linkages/gears 60, 61, 62, 63, 64, 65, 66, 67, 68, necessary to selectively position the doors 28, 30, 32, 34, 36. As used herein, the term “gear” may refer to any component including a feature for engaging and transferring a rotational motion of the rotating component to another distinct component. The term “gear” may accordingly refer to an elongate arm having an engaging feature, such as teeth, disposed at a first end thereof for transferring the rotational motion and a rotatable connection disposed at a second end thereof to allow the arm to rotate about the second end.

The mounting bracket 39 is configured to be mounted to an exterior surface of the main housing 12, and more specifically to an exterior surface of one of the housing shells 16. The mounting bracket 39 may be mounted to the main housing 12 using any known method or coupling device. In some embodiments, the mounting bracket 39 includes apertures (not shown) configured for alignment with apertures formed in the main housing 12 to allow for traditional fastening devices to be fed therethrough to couple the mounting bracket 39 to the main housing 12. In other embodiments, the mounting bracket 39 is coupled to the main housing 12 by connection of the components of the control mechanism 38 to each of the temperature door 28 and the mode doors 30, 32, 34, 36 as explained in greater detail hereinafter.

The mounting bracket 39 and the exterior surface of the main housing 12 cooperate to enclose the cam gear 40, the cam gear 50, and the linkages/gears 64, 65, 66, 67 disposed therein.

The actuator 3 may be coupled to the mounting bracket 39. The actuator 3 may be coupled to the mounting bracket 39 using any known coupler such as threaded fasteners, for example. The actuator 3 may be any known actuator capable of producing and transferring torque to the components forming the control mechanism 38. The actuator 3 may be mechanically operated, electrically operated, fluid operated, or otherwise operated, for example. The actuator 3 may be an electronic motor driven rotary actuator, as a non-limiting example. A portion of the actuator 3 extend through the mounting bracket 39 to engage a portion of the cam gear 40.

The cam gear 40 is rotatably coupled to the actuator 3. The actuator 3 accordingly is configured to transfer torque to the cam gear 40 to cause the cam gear 40 to rotate about a rotational axis 41 thereof. The cam gear 40 is mechanically engaged with the actuator 3 by any known coupling or structure suitable for transferring rotational motion between two rotating components. The cam gear 40 may for example include an axle (not shown) extending therefrom in parallel to the rotational axis 41 and engaging a rotating portion of the actuator 3 to transfer the rotational motion of the actuator 3 to the cam gear 40. Alternatively, the actuator 3 may include a projecting rotating arm extending into and engaging a surface defining an aperture formed in the cam gear 40 to transfer the rotational motion of the actuator 3 to the cam gear 40. The cam gear 40 is accordingly caused to rotate about the rotational axis 41 in response to rotation of the actuator 3.

The cam gear 40 further includes an outer circumferential surface 42 including a plurality of teeth 43 extending radially outwardly from the outer circumferential surface 42 relative to the rotational axis 41. The cam gear 40 may include any suitable number of the teeth 43 and the teeth 43 may have any suitable size and profile for mating with teeth 53 of the cam gear 50. Each of the teeth 43 may for example have an involute tooth profile, but any suitable tooth profile may be used without departing from the scope of the present invention. The cam gear 40 may be a spur gear wherein the outer circumferential surface 42 of the cam gear 40 may be substantially circular in shape and arranged concentrically relative to the rotational axis 41 of the cam gear 40.

The cam gear 40 further includes a planar face 44 and an opposite planar face 46 extending between the rotational axis 41 and the outer circumferential surface 42 thereof while arranged on a plane perpendicular to the rotational axis 41. A cam track 45 is formed in the face 44 and a cam track 47 is formed in the face 46. The cam track 45 and/or the cam track 47 may be a slot or opening having a preselected shape. The cam track 45 and/or the cam track 47 has a varying distance from the rotational axis 41 of the cam gear 40 as the cam track 45 and/or the cam track 47 extends in a circumferential direction in respect of the cam gear 40 around the rotational axis 41.

The cam gear 50 is rotatably coupled to the mounting bracket 39 about a rotational axis 51 thereof arranged in parallel to the rotational axis 41 of the cam gear 40. The cam gear 50 is rotatably coupled to the mounting bracket 39 using any known coupling or structure suitable for transferring rotational motion. The cam gear 50 may for example include an axle (not shown) extending in parallel to the rotational axis 51 and rotatably engaging a surface defining an aperture (not shown) formed in the mounting bracket 39 to allow the cam gear 50 to rotate about the rotational axis 51 relative to the stationary mounting bracket 39. Alternatively, an axle (not shown) may extend from the mounting bracket 39 for engaging a surface of the cam gear 50 defining a central aperture therein, for example.

The cam gear 50 further includes an outer circumferential surface 52 including a plurality of the teeth 53 extending radially outwardly from the outer circumferential surface 52 relative to the rotational axis 51. The cam gear 50 may include any suitable number of the teeth 53 and the teeth 53 may have any suitable size and profile for mating with and operably engaging the teeth 43 of the cam gear 40. Each of the teeth 53 may for example have an involute tooth profile, but other tooth profiles may be used without departing from the scope of the present invention. The cam gear 50 may be a spur gear wherein the outer circumferential surface 52 of the cam gear 50 may be substantially circular in shape and arranged to rotate about the rotational axis 51 of the cam gear 50.

The cam gear 50 further includes a planar face 54 and an opposite planar face 56 formed between the rotational axis 51 and the outer circumferential surface 52 thereof while arranged on a plane perpendicular to the rotational axis 51. A cam track 57 is formed on the face 56 of the cam gear 50. The cam track 57 has a varying distance from the rotational axis 51 of the cam gear 50 as the cam track extends in a circumferential direction in respect of the cam gear 50 around the rotational axis 51. A shape of the cam track 57 is described in greater detail hereinafter with reference to the operation of the control mechanism 38.

The cam gear 40 and the cam gear 50 may have the same outer diameter resulting in the cam gear 40 and the cam gear 50 having a gear ratio of 1:1. Accordingly, when the cam gear 40 is rotated through a given angle of rotation, the cam gear 50 will similarly be rotated through the same angle of rotation in a rotational direction opposite the cam gear 40. However, one skilled in the art should appreciate that different gear ratios and configurations may be used between the cam gear 40 and the cam gear 50 without departing from the scope of the present invention.

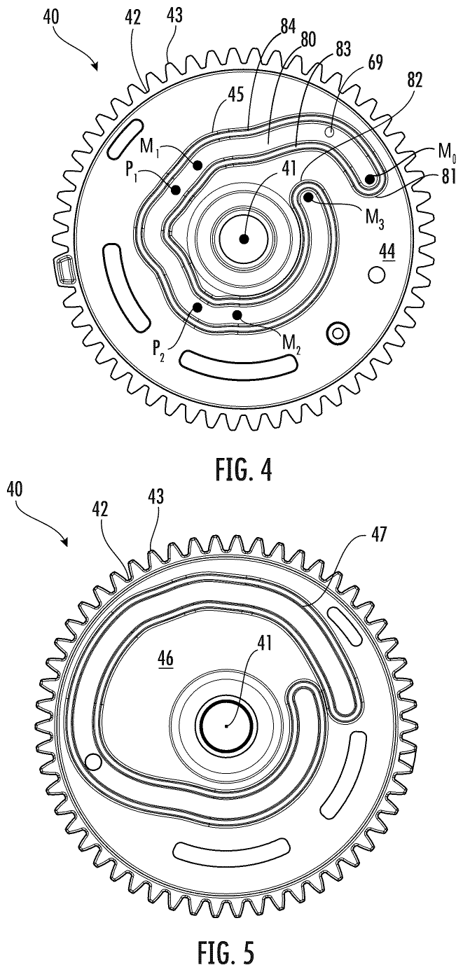

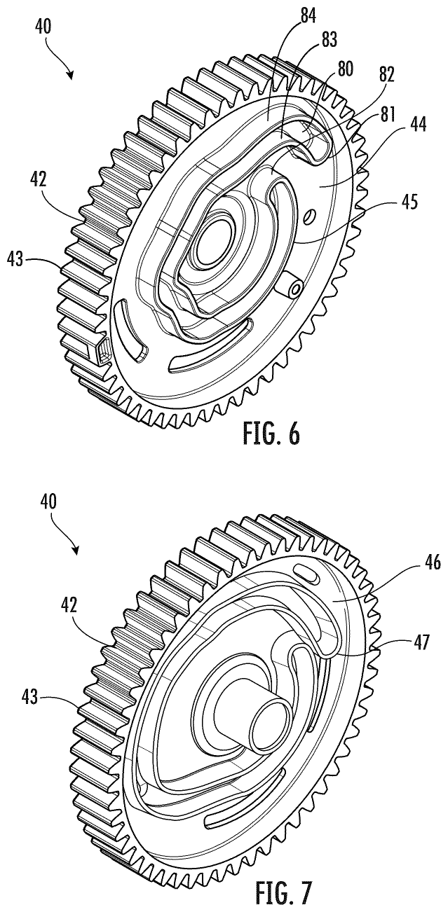

FIGS. 4-7 illustrates the cam gear 40 in the absence of the remainder of the control mechanism 38 to illustrate the shape of each of the cam tracks 45, 47. As best seen in FIG. 4, the cam track 45 forms a continuous path 80 defined by a first end 81, a second end 82, a radially inner wall 83, and radially outer wall 84 extending between the first and second ends 81, 82, respectively. A geometry of the cam track 45 mitigates mechanical hysteresis in one or more of the selectively positionable doors (e.g., the inlet door, the temperature door 28, and the mode doors 30, 32, 34, 36) by creating the same conditions from either approaching side regardless of the rotational direction of the cam gear 40. The initial normalized actuator rotation position of 0.0 corresponds to a cam follower 69 of the linkage/gear 68 slidably engaged with a portion of the cam track 45 indicated as position M₀. In some embodiments, when the cam follower 69 of the linkage/gear 68 is at the position M₀, the air-handling system 1 is operating in the “panel mode” with the mode doors 30, 34 in the closed first position and the mode doors 32, 36 in the open second position. An initial rotation of the actuator 3 from the normalized actuator rotation position of 0.0 first causes the cam gear 40 to rotate about the rotational axis 41 thereof. The rotation of the cam gear 40 is shown from the perspective of FIGS. 3 and 4 as being in a clockwise rotational direction. The rotation of the cam gear 40 causes the cam gear 50 to rotate in an opposite rotational direction (counter-clockwise from the perspectives of FIG. 3). As the cam gear 40 rotates about the rotational axis 41 thereof, the cam follower 69 of the linkage/gear 68 is caused to follow the shape of the cam track 45. Similarly, as the cam gear 50 rotates about the rotational axis 51 thereof, a cam follower 70 of the linkage/gear 65 (shown in FIG. 2) is caused to follow the shape of the cam track 57.

As shown in FIG. 4, as the cam gear 40 is initially rotated in the clockwise rotational direction, the cam follower 69 will follow the path 80 generally contacting the outer wall 84 of the cam track 45 moving in a direction away from the position M₀ and toward a position along the cam track 45 indicated as position M₁. The movement of the cam follower 69 toward the position M₁ and contacting the outer wall 84 of the cam track 45 causes the cam follower 69 to move in a direction radially inwardly toward the rotational axis 41 of the cam gear 40. This movement toward the rotational axis 41 causes the linkage/gear 68 to rotate about a rotational axis thereof in a counter-clockwise rotational direction from the perspective of FIG. 3. The rotation of the linkage/gear 68 thereby causes the linkages/gears 60, 61, 62, 63 operably connected to the cam gear 40 to move relative thereto. The linkages/gears 60, 61, 62, 63, 68 thereby transfer the rotational motion of the cam gear 40 to rotate the mode doors 32, 36 away from the second position to an intermediate position.

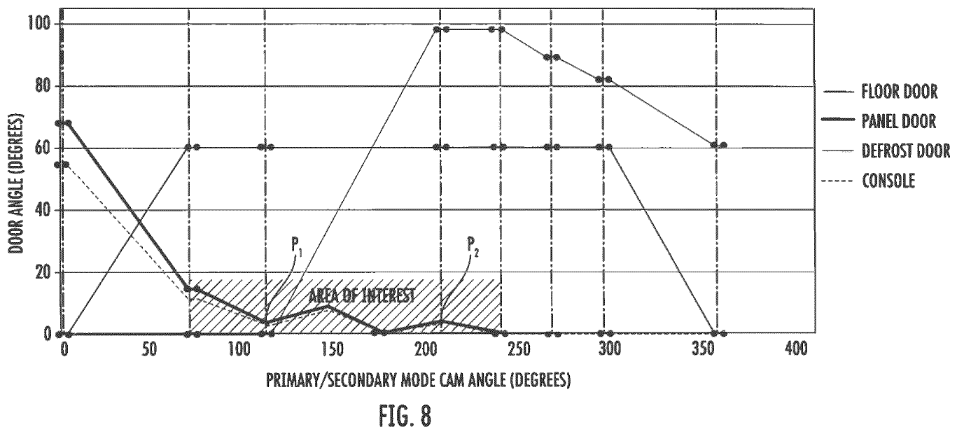

Further rotation of the cam gear 40 about the rotational axis 41 thereof in the clockwise rotational direction causes the cam follower 69 of the linkage/gear 68 to move away from the position M₁ and to follow the path 80 generally contacting the outer wall 84 of the cam track 45 toward a position on the cam track 45 indicated as position M₂. The cam track 45 includes one or more radially inward “valley” segments (e.g., indicated as P₁ in FIGS. 4 and 8) and one or more radially outward “peak” segments (e.g., indicated as P₂ in FIGS. 4 and 8) between the positions M₁ and M₂. In some embodiments, the valley segments (e.g., P₁) have a distance from the rotational axis 41 less than a distance of a leading portion of the path 80 of the cam track 45 adjacent the valley segment and less than a distance of a trailing portion of the path 80 of the cam track 45 adjacent the valley segment opposite the leading portion. When the cam gear 40 is rotated about the rotational axis 41 in the clockwise rotational direction, the cam follower 69 will follow the path 80 generally contacting the outer wall 84 of the cam track 45 as it travels towards and away from the position P₁. In certain embodiments, the peak segments (e.g., P₂) have a distance from the rotational axis 41 greater than a distance of a leading portion of the path of the cam track 45 adjacent the peak segment and greater than a distance of a trailing portion of the path of the cam track 45 adjacent the peak segment opposite the leading portion. In some instances, the leading portion and/or the trailing portion of the path of the cam track 45 may also form part of the valley segments. When the cam gear 40 is rotated about the rotational axis 41 in the clockwise rotational direction, the cam follower 69 will follow the path 80 generally between the inner and outer walls 83, 84, respectively, of the cam track 45 as it travels through the leading portion towards the position P₂ and through the trailing portion away from the position P₂. However, at the position P₂, the cam follower 69 generally contacts the inner wall 83 of the cam track 45. The valley and/or peak segments may be configured to cause an intentional biasing of the cam follower 60 of the linkage/gear 68 to either the inner wall 83 or the outer wall 84 of the cam track 45 as the mode doors 32, 36 approach the desired positions thereof. This allows for any flex in the linkages/gears 60, 61, 62, 63 to approach a desired angle under the same stress conditions when the cam gear 40 rotates from either the clockwise or the counter-clockwise rotational directions. Accordingly, the mechanical hysteresis of the mode doors 32, 36 is reduced, improving temperature and airflow accuracy of the air-handling system 1. In some embodiments, as shown in FIG. 8, when the cam follower 69 of the linkage/gear 68 is at the position P₁, the air-handling system 1 is operating in the “panel and floor mode” with the mode door 30 in the closed first position, the mode door 34 in the open second position, and the mode doors 32, 36 in the intermediate position. Additionally, when the cam follower 69 of the linkage/gear 68 is at the position P₂, the air-handling system 1 is operating in the “panel, floor, and defrost mode” with each of the mode doors 30, 32, 34, 36 in one of the open second or intermediate positions. In one preferred embodiment, as shown in FIG. 8, when the cam follower 69 of the linkage/gear 68 is at the position P₂, the air-handling system 1 is operating in the “panel, floor, and defrost mode” with the mode doors 30, 34 in the open second position and the mode doors 32, 36 in the intermediate position.

As the cam gear 40 is rotated in the clockwise rotational directional from the positions M₁ and M₂, the cam follower 69 moves along the path 80 again generally contacting the outer wall 84 of the cam track 45 in a direction radially inwardly toward the rotational axis 41 of the cam gear 40. This movement toward the rotational axis 41 causes the linkage/gear 68 to rotate about a rotational axis thereof in a counter-clockwise rotational direction from the perspective of FIG. 3. The rotation of the linkage/gear 68 thereby causes the linkages/gears 60, 61, 62, 63 operably connected to the cam gear 40 to move relative thereto. The linkages/gears 60, 61, 62, 63, 68 thereby transfers the rotational motion of the cam gear 40 to rotate the mode doors 32, 36 away from the intermediate position to the second position.

Further rotation of the cam gear 40 about the rotational axis 41 thereof in the clockwise rotational direction causes the cam follower 69 of the linkage/gear 68 to move away from the position M₂ and to follow the path 80 of the cam track 45 generally contacting the outer wall 84 of the cam track 45 toward a position on the cam track 45 indicated as position M₃. In some embodiments, when the cam follower 69 of the linkage/gear 68 is at the position M₃, the air-handling system 1 is operating in the “defrost mode” with the mode door 30 in the open second position and the mode doors 32, 34, 36 in the closed first position. The cam track 45 maintains a substantially constant distance from the rotational axis 41 of the cam gear 40 between the positions M₂ and M₃, thereby causing a position of the cam follower 69 to remain substantially unchanged relative to the rotational axis 41. Accordingly, the constant distance of the cam track 45 relative to the rotational axis 41 between the positions M₂ and M₃ causes the linkage/gear 68 to remain substantially stationary while not rotating about the rotational axis thereof. The lack of rotation of the linkage/gear 68 in turn causes each of the linkages/gears 60, 61, 62, 63 and the mode doors 32, 36 to remain in their second positions until the actuator 3 cause a rotational movement of the cam gear 40 in the counter-clockwise rotational direction.

In certain embodiments, when the cam gear 40 is rotated in the counter-clockwise rotational direction, the cam follower 69 of the linkage/gear 68 travels along the path 80 generally contacting the inner wall 83 of the cam track 45 as it travels from the position M₃ to M₀ with the exception that the cam follower 69 will move in the path 80 generally between the inner and outer walls 83, 84, respectively, of the cam track 45 as it travels through the leading portion towards the position P₁ and through the trailing portion away from the position P₁ and, at the position P₂, the cam follower 69 generally contacts the outer wall 84 of the cam track 45.

It should therefore be clear that a distance of the cam follower 69 from the rotational axis 41 of the cam gear 40 directly affects a rotational position of the linkage/gear 68, which in turn directly affects the rotational positions of each of the linkages/gears 60, 61, 62, 63 and thereby the mode doors 32, 36. As a general principle, portions of the cam track 45 having a constant distance from the rotational axis 41 of the cam gear 40 (also referred to as holding portions of the cam track 45) will result in no rotation of the mode doors 32, 36 during rotation of the actuator 3 while portions of the cam track 45 having a varying distance from the rotational axis 41 (also referred to as variable portions of the temperature cam track 45) will result in rotation of the mode doors 32, 36 during rotation of the actuator 3.

FIG. 8 is a diagram showing a relationship between angle of the cam gears 40, 50 and a rotational position of each of the mode doors 30, 32, 34, 36.

The control mechanism 38 is accordingly configured to rotate each of the temperature door 28 and the mode doors 30, 32, 34, 36 to predetermined rotational positions associated with predetermined angles of rotation of the actuator 3 driving the control mechanism 38, and the predetermined rotational position of the doors 28, 30, 32, 34, 36 is determined by the shape of the cam tracks 45, 47, 57. As described hereinabove, the control mechanism 38 may also be configured to rotate the inlet door to predetermined rotational positions associated with predetermined angles of rotation of the actuator 3 driving the control mechanism 38, and the predetermined rotational position of the inlet door may be determined by the shape of at least one of the cam tracks 45, 47, 57. The control mechanism 38 may be further configured to provide independent volume and temperature control for each of the modes of operation of the air-handling system 1.

As should be understood, the actuator 3 may be caused to rotate in either of two rotational directions to adjust the air-handling system 1 to any of the operating modes associated with any of the normalized actuator rotation positions. Accordingly, the air-handling system 1 allows for the temperature door 28 and the mode doors 30, 32, 34, 36 (as indicated in the diagram of FIG. 8) to be adjusted to a variety of positions resulting in a variety of operating modes of the air-handling system 1 by means of the rotation of the actuator 3. A temperature of the flow of air may accordingly be adjusted from cold to hot while the air is delivered exclusively to the upper vents 102 of the passenger compartment 104, exclusively to the lower vents 103 of the passenger compartment 104, and to each of the upper vents 102 and the lower vents 103 of the passenger compartment 104. Additionally, a percentage of the flow of air delivered to the lower vents 103 and the upper vents 102 may be varied while a temperature of the air is maximized or minimized.

It should be appreciated by one skilled in the art that the general principles of operation of the control mechanism 38 may be adapted for use with a variety of different control mechanisms having substantially similar components but different sizes, packaging arrangements, and configurations.

It should also be understood that the actuator 3 may be configured to operably engage and drive the cam gear 50 instead of the cam gear 40 without altering the principles of operation of the control mechanism 38. Additionally, it should be understood that the aforementioned normalized actuator rotation positions indicated as changing a volume and temperature of the flow of air and the mode of operation of the air-handling system 1 are dependent on the contour of each of the cam tracks 45, 47, 57, hence alteration of any one of the cam tracks 45, 47, 57 may result in the air flow volume and temperature and the mode of operation of the air-handling system 1 changing for different values of the normalized actuator rotation positions.

It should also be appreciated by one skilled in the art that the general concepts relating to the control mechanism 38 may applied to the control of any variety of different rotational components disposed within the main housing 12.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An air-handling system for a heating, ventilation, and air conditioning system of a motor vehicle having a passenger compartment, the air-handling system comprising:
a main housing having one or more selectively positionable doors rotatably disposed therein; and
a control mechanism including a first cam gear rotatable about a rotational axis, wherein the first cam gear includes a cam track formed on a first face thereof, wherein a shape of the cam track determines a rotational position of at least one of the one or more selectively positionable doors, wherein the cam track includes a first end, a second end, and a continuous path extending between the first end and the second end, and wherein the continuous path includes at least one at least one radially outward segment having a distance from the rotational axis greater than a distance from the rotational axis of a leading portion of the continuous path and a distance from the rotational axis of a trailing portion of the continuous path.

2. The air-handling system of claim 1, wherein the cam track on the first face of the first cam gear extends in a circumferential direction around the rotational axis.

3. The air-handling system of claim 1, wherein the control mechanism further comprises a linkage/gear including a cam follower slidably engaging the cam track on the first face of the first cam gear.

4. The air-handling system of claim 3, wherein the linkage/gear rotates in response to the cam follower sliding along the cam track on the first face of the first cam gear.

5. The air-handling system of claim 3, wherein the shape of the cam track biases the cam follower to one side of the cam track to mitigate a mechanical hysteresis of the one or more selectively positionable doors.

6. The air-handling system of claim 1, wherein the first cam gear includes a cam track on a second face thereof.

7. The air-handling system of claim 6, wherein a shape of the cam track on the second face of the first cam gear determines a rotational position of at least one of the one or more selectively positionable doors.

8. The air-handling system of claim 6, wherein the cam track on the second face of the first cam gear extends in a circumferential direction around the rotational axis.

9. The air-handling system of claim 6, wherein the control mechanism further comprises a linkage/gear including a cam follower slidably engaging the cam track on the second face of the first cam gear.

10. The air-handling system of claim 9, wherein the linkage/gear rotates in response to the cam follower sliding along the cam track on the second face of the first cam gear.

11. The air-handling system of claim 1, wherein the control mechanism further comprises a second cam gear having a rotational axis.

12. The air-handling system of claim 11, wherein the second cam gear includes a cam track on a face thereof.

13. The air-handling system of claim 12, wherein a shape of the cam track on the face of the second cam gear determines a rotational position of at least one of the one or more selectively positionable doors.

14. The air-handling system of claim 12, wherein the cam track on the face of the second cam gear extends in a circumferential direction around the rotational axis of the second cam gear.

15. The air-handling system of claim 12, wherein the control mechanism further comprises a linkage/gear including a cam follower slidably engaging the cam track on the face of the second cam gear.

16. The air-handling system of claim 1, wherein the control mechanism is configured to rotate each of the one or more selectively positionable doors to predetermined rotational positions associated with predetermined angles of rotation of at least one actuator driving the control mechanism.

17. The air-handling system of claim 1, wherein at least one of the one or more selectively positionable doors rotatably disposed in the main housing is a temperature door or a mode door.

18. The air-handling system of claim 17, wherein a shape of the cam track on the first face of the first cam gear determines a rotational position of the temperature door or the mode door.

19. The air-handling system of claim 17, wherein the control mechanism further comprises at least one linkage/gear operably connecting the temperature door or the mode door to the first cam gear.

20. The air-handling system of claim 17, wherein the control mechanism is configured to rotate the temperature door or the mode door to predetermined rotational positions associated with predetermined angles of rotation of at least one actuator driving the control mechanism.
